(19) United States
(12) Patent Application Publication
(10) Pub. No.: US 2004/0220705 A1
(43) Pub. Date: Nov. 4, 2004

(54) Visual classification and posture estimation of multiple vehicle occupants

(76) Inventors: Otman Basir, Waterloo (CA); David Bullock, Waterloo (CA); Emil Breza, Beamsville (CA)

Correspondence Address: CARLSON, GASKEY & OLDS, P.C., 400 WEST MAPLE ROAD, SUITE 350, BIRMINGHAM, MI, 48009, US

(21) Appl. No.: 10/801,096

(22) Filed: Mar. 15, 2004

Related U.S. Application Data
(60) Provisional application No. 60/454,276, filed on Mar. 13, 2003.

(51) Int. Cl. G06F 17/00

(52) U.S. Cl. 701/1; 701/45

(57) ABSTRACT

A vehicle occupant detection/classification and posture estimation system includes a camera equipped with a wide-angle (“fish eye”) lens and mounted in the vehicle headliner captures images of all vehicle seating areas. Image processing algorithms can be applied to the image to account for lighting, motion, and other phenomena. A spatial-feature vector is then generated which numerically describes the visual content of each seating area. This descriptor is the result of a number of digital filters being run against a set of sub-images, derived from pre-defined window regions in the original image. This spatial-feature vector is used as an input to an expert classifier function, which classifies each seating area as best representing a scenario in which the seat is (i) empty, (ii) occupied by an adult, (iii) occupied by a child, (iv) occupied by a rear-facing infant seat (RFIS), (v) occupied by a front-facing infant seat (FFIS), or (vi) occupied by an undetermined object. Seating areas which are determined to be occupied by an adult are further sub-classified as (i) occupant in position, or (ii) occupant out-of-position. Out-of-position occupants are occupants who are determined to be within the “keep out zone” of the airbag.

This application claims priority to Provisional Application U.S. Ser. No. 60/545,276, filed Mar. 13, 2003.

### BACKGROUND OF THE INVENTION

This invention relates to the field of image-based vehicle occupant detection, classification, and posture estimation. More specifically, the invention uses an imaging system in order to simultaneously monitor and classify all vehicle seating areas into a number of occupancy classes, the minimum of which includes (i) empty, (ii) occupied by an in-position adult, (iii) occupied by an out-of-position occupant, (iv) occupied by a child passenger, (v) occupied by a forward facing infant seat, (vi) occupied by a rear facing infant seat.

Automobile occupant restraint systems that include an airbag are well known in the art, and exist in nearly all new vehicles being produced. While the introduction of passenger-side airbags proved successful in reducing the severity of injuries suffered in accidents, they have proven to be a safety liability in specific situations. Airbags typically deploy in excess of 200 mph and can cause serious, sometimes fatal, injuries to small or out-of-position occupants. These hazardous situations include the use of rear-facing infant seats (RFIS) in the front seat of a vehicle. While it is agreed upon that the safest location for a RFIS is the back seat, some vehicles do not have a back seat option. While RFIS occupants can be injured from indirect exposure to the force of an airbag, small children and occupants in forward-facing infant seats (FFIS) are at risk of injury from direct exposure to the airbag deployment. Beyond safety concerns, there is also a high financial cost (>$700) associated with replacing a deployed airbag. This is a motivation for the deactivation of an airbag when the passenger seat has been detected to be empty, or occupied by an infant passenger. Dynamic suppression of airbag refers to the technique of sensing when an occupant is within the “keep out zone” of an airbag, and temporarily deactivating the airbag until the occupant returns to a safe seating posture. The “keep out zone” refers to the area inside the vehicle which is in close proximity to the airbag deployment location. Occupants who are positioned within this keep-out zone would be in danger of serious injury if an airbag were to deploy. Thus, when an occupant is within the keep-out zone the airbag is dynamically suppressed until the occupant is no longer within this zone. Airbag technology has started to be installed in rear seats, in addition to the front driver and passenger seats. This has created a need for occupancy classification, detection, and posture estimation in all vehicle seats. Ideally, this task could be accomplished by a single sensor, such as the invention outlined in this document.

Various solutions have been proposed to allow the modification of an airbag's deployment when a child or infant is occupying the front passenger seat. This could result in an airbag being deployed at a reduced speed, in an alternate direction, or not at all. The most basic airbag control systems include the use of a manual activation/deactivation switch controllable by the driver. Due to the nature of this device, proper usage could be cumbersome for the driver, especially on trips involving multiple stops. Weight sensors have also been proposed as a means of classifying occupants, but have difficulty with an occupant moving around in the seat, an over-cinched seat belt on an infant seat, and can misclassify heavy but inanimate objects. Capacitance-based sensors have also been proposed for occupant detection, but can have difficulty in the presence of seat dampness.

Vision-based systems offer an alternative to weight-based and capacitance-based occupant detection systems. Intuitively we know that vision-based systems should be capable of detecting and classifying occupants, since humans can easily accomplish this task using visual senses alone. A number of vision-based occupant detection/classification systems have been proposed. In each of these systems one or more cameras are placed within the vehicle interior and capture images of the front passenger seating seat region. The seat region is then observed and the image is classified into one of several pre-defined classes such as “empty,” “occupied,” or “infant seat.” This occupancy classification can then act as an input to the airbag control system.

Many of these systems, such as U.S. Pat. No. 5,531,472 to Steffens, rely on a stored visual representation of an empty passenger seat. This background template can then be subtracted from an observed image in order to generate a segmentation of the foreign objects (foreground) in the vehicle. This technique is highly problematic in that it relies on the system having a known image stored of the vehicle interior when empty, and will fail if cosmetic changes are made to the vehicle such as a reupholstering of the seat. As well, unless seat position and angle sensors are used (as suggested by Steffens), the system will not know which position the seat is in and will therefore have difficulty in extracting a segmented foreground image.

Other approaches include the generation of a set of image features which are then compared against a template reference set of image features in order to classify the image. This technique is used in U.S. Pat. No. 5,528,698 to Stevens, and U.S. Pat. No. 5,983,147 to Krumm, in both of which an image is classified as being “empty,” “occupied,” or having a “RFIS.” The reference set represents a training period which includes a variety of images within each occupant classification. However, generation of an exhaustive and complete reference set of image features can be difficult. As well, these systems are largely incapable of interpreting a scenario in which the camera's field-of-view is temporarily, or permanently, occluded.

Some occupant detection systems have made use of range images derived from stereo cameras. Systems such as those in U.S. Pat. No. 5,983,147 to Krumm discuss the use of range images for this purpose, but ultimately these systems still face the challenges of generating a complete reference set, dealing with occlusion, and a means for segmenting the foreground objects.

All of these systems which rely on a training set require that the classifier function be retrained if the camera mount location is moved, or used in a different vehicle. Finally, each of these systems is limited to observing a single seating area. Monitoring of multiple seating areas would require multiple devices to be installed, each focused on a different seating area.

### SUMMARY OF THE INVENTION

This invention proposes an alternative in which all seating areas can be monitored from a single camera device. This invention is a vision-based device for use as a vehicle occupant detection/classification and posture estimation system. The end uses of such a device include acting as an input to an airbag control unit and dynamic airbag suppression.

A wide-angle (“fish eye”) lens equipped camera is mounted in the vehicle headliner such that it can capture images of all seating areas in the vehicle simultaneously. Image processing algorithms can be applied to the image to account for lighting, motion, and other phenomena. A spatial-feature vector is then generated which numerically describes the content of each seating area. This descriptor is the result of a number of digital filters being run against a set of sub-images, derived from pre-defined window regions in the original image. This spatial-feature vector is then used as an input to an expert classifier function, which classifies the seating area as best representing a scenario in which the seat is (i) empty, (ii) occupied by an adult, (iii) occupied by a child, (iv) occupied by a rear-facing infant seat (RFIS), (v) occupied by a front-facing infant seat (FFIS), or (vi) occupied by an undetermined object. When an occupant is determined to be in a seating area, the posture is estimated by further classifying them as (i) in position, or (ii) out-of-position and within the “keep out zone” of the airbag. When an occupant is within the “keep out zone,” the airbag is dynamically suppressed to ensure the deployment does not injure an occupant who is positioned close to the deployment site. This expert classifier function is trained using an extensive sample set of images representative of each occupancy classification. Even if this classifier function has not encountered a similar scene through the course of its training period, it will classify each seating area in the captured image based on which occupancy class generated the most similar filter response. Each seating area's occupancy classification from the captured image is then smoothed with occupancy classifications from the recent past to determine a best-estimate occupancy state for the seating area. This occupancy state is then used as the input to an airbag controller rules function, which gives the airbag system deployment parameters, based on the seat occupancy determined by the system.

This invention makes no assumptions of a known background model and makes no assumptions regarding the posture or orientation of an occupant. The device is considered to be adaptive as once the expert classifier function is trained on one vehicle, the system can be used in any other vehicle by taking vehicle measurements and adjusting the system parameters of the device. The system may be used in conjunction with additional occupant sensors (e.g. weight, capacitance) and can determine when the visual input is not reliable due to camera obstruction or black-out (no visible light) conditions. In the absence of additional non-visual sensors, the device can sense when it is occluded or unable to generate usable imagery. In such a situation, the airbag will default to a pre-defined “safe state.”

### BRIEF DESCRIPTION OF THE DRAWINGS

Other advantages of the present invention can be understood by reference to the following detailed description when considered in connection with the accompanying drawings wherein:

FIG. 1 schematically shows an occupant classification system according to the present invention.

FIG. 2 is a high-level system flowchart, showing the operation of the occupant classification system of FIG. 1.

FIG. 3 is a flowchart showing the occupancy classification of all seating areas based on a single image.

FIG. 4 is a flowchart showing the temporal smoothing to give a final seat occupancy classification for a seating area.

### DETAILED DESCRIPTION OF THE PREFERRED EMBODIMENTS

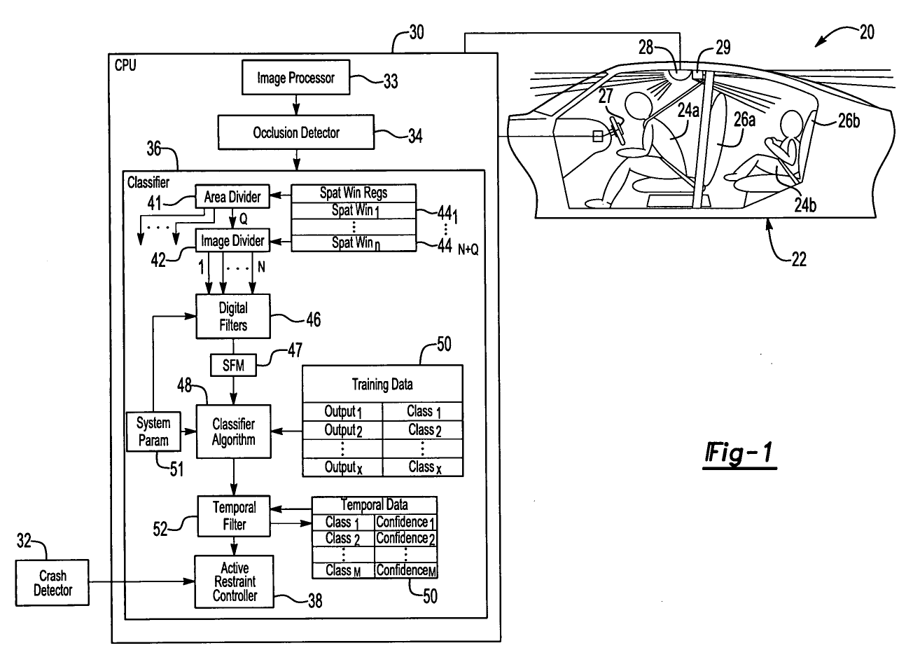

An occupant classification system 20 is shown schematically in FIG. 1 installed in a vehicle 22 for classification of occupants 24a-d in occupant areas 26a-d (in this example, seats 26a-d). The classification of the occupants 24 may be used, for example, for determining whether or how to activate an active restraint 27 (such as an air bag) in the event of a crash. The occupant classification system 20 includes a camera 28 and a computer 30 having a processor, memory, storage, etc. The computer 30 is appropriately programmed to perform the functions described herein and may also include additional hardware that is not shown, but would be well within the skill of those in the art.

The camera 28 is directed toward the occupant seating areas 26, such that all of the occupant seating areas 26 are within the camera's 28 field of view. The camera 28 may include a wide angle lens, lens filters, an image sensor, a lens mount, image sensor control circuitry, a mechanical enclosure, and a method for affixing the camera 28 to the vehicle interior. The camera 28 may also include a digital encoder, depending on the nature of the image sensor. The camera 28 may also include a light source 29, such as an LED. The camera 28 may be mounted in the vehicle headliner such that all seating areas 26 are within the field of view.

The computer 30 is suitably programmed to include an image processor 33, occlusion detector 34, occupant classifier 36 and active restraint controller 38. The classifier 36 further includes an area image divider 41, for diving the image into Q images, with each image being focused on a particular seating area 26. A spatial image divider 42 divides each seating area image into N subimages. The seating areas 26 and subimages are defined by spatial windows which are defined by spatial window registers 44_{1-N+Q}. The subimages from the image divider 42 are each sent to a plurality of digital filters 46. In the preferred embodiment, the digital filters 46 may take the form of FIR (finite impulse response) filters, which can be tuned to extract quantitative image descriptors such as texture, contours, or frequency-domain content. The digital filters 46 may produce scalar values, histograms, or gradients. In all cases, these filter outputs are grouped together sequentially to produce a single spatial-feature matrix 47 which is sent to the expert classifier algorithm 48

The outputs of the digital filters 46 are all low-level image descriptors; that is, they quantitatively describe the low-level features of an image which include, but are not limited to, edge information, contour information, texture information, contrast information, brightness information, etc. In our preferred embodiment these descriptors model a number of regional attributes in a subimage such as: how complex the texture patterns are in a region, how natural the contours appear to be, how strongly the edges contrast with each other, etc. The answers to these questions classify the occupant 24, as opposed to a high-level approach which relies on questions such as: where is the occupant's head, how far apart are the occupants eyes, etc. By combining these low-level descriptors into a spatially context-sensitive format (the spatial feature matrix 47) the image content is described robustly with a small number of parameters.

Two types of filters 46 are used in the current system: FIR filters (finite impulse response filters) and Algorithmic Filters. FIR filters essentially apply a convolution operator to each pixel in order to generate a numerical value for every pixel which is evaluated. The algorithmic filter uses an algorithm (such as a contour following algorithm which may measure the length of the contour to which the examined pixel is attached) to generate a numerical value for every pixel which is evaluated.

These digital filter outputs may be represented in a number of ways, some of which produce a single value for a sub-window (such as counting the number of edge pixels in a subimage, or counting the number of edges which point upwards) while some produce a group of numbers (such as representing filter outputs via histograms or gradients).

Either way, in all cases, the digital filter 46 outputs are represented in some way (scalar values, histograms, gradients, etc.) and then placed together end-to-end to form the spatial-feature matrix 47. The spatial-feature matrix 47 is the input data for the neural network, while the output vector is the classification likelihoods for each of the classification levels (empty, rfis, ffis, child, adult, object, etc.)

The expert classifier algorithm 48 accesses stored training data 50, which comprises known sets of filtered outputs for known classifications. The output of the classifier algorithm 48 is received by temporal filter 52 and stored in the temporal filter data set 50, which includes the previous M output classifications 56 and an associated confidence rating 58 for each.

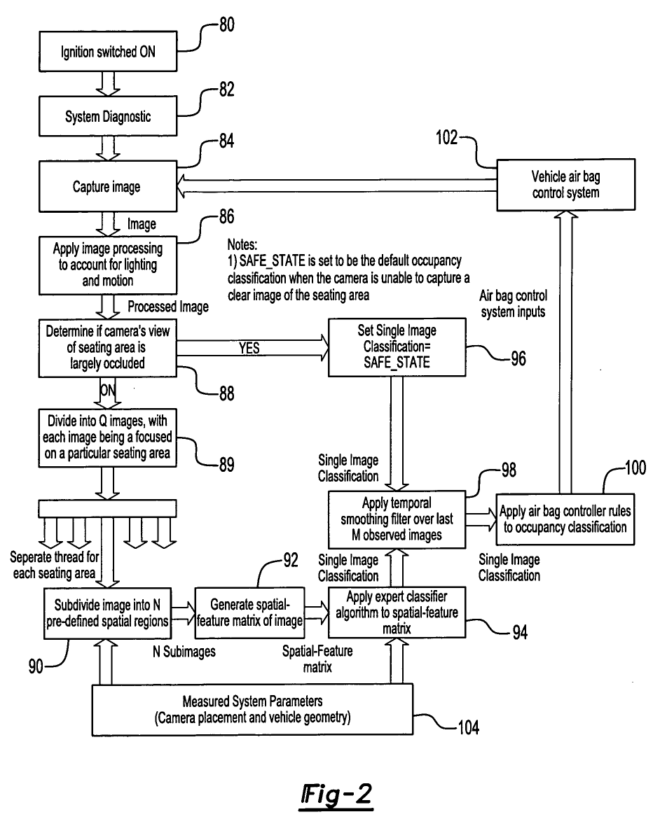

The overall operation of the occupant classification system 20 of FIG. 1 will be described with respect to the flow chart of FIG. 2. At the time of vehicle ignition in step 80, the device performs a system diagnostic in step 82. This includes a formal verification of the functionality of all system components. The camera 28 captures an image of the occupant area 26 in step 84. The image is processed by the image processor 33 in step 86. Situations such as night time driving and underground tunnels will result in low-light levels, making image capture problematic. The system 20 compensates for low-light level image capture through a combination of image processing algorithms, external light source 29, and use of ultra-sensitive image sensors. After image capture and encoding, a number of image processing filters and algorithms may be applied to the digital image in step 86 by the image processor 33. This image processing can accommodate for low light levels, bright lighting, shadows, motion blur, camera vibration, lens distortion, and other phenomena. The output from the image processor 33 is an altered digital image.

Despite placement of the camera 28 in the vehicle headliner, or other high-vantage positions, situations may arise in which the camera's view of the occupant area 26 is occluded. Such scenarios include vehicles with an excessive amount of cargo, occupant postures in which a hand or arm occludes the camera's entire field-of-view, or vehicle owners who have attempted to disable the camera device by affixing an opaque cover in front of the lens. In such situations it is desirable to have the occlusion detector 34 determine whether there is occlusion in step 88. In the presence of occlusion, the system 20 reverts to a default “safe state” in step 96. The safe state may be defined to be “empty” such that the active restraint is never activated, or such that the active restraint is activated with reduced force.

Once an image has been processed and determined to contain usable data, it is divided into Q images in step 89, each of which is focused on a particular seating area 26a-d. This image extraction is done using specific knowledge of the vehicle geometry and camera placement. Typically Q will be 2, 4, 5, or 7, depending on the nature of the vehicle. Once these images have been extracted, each image is classified into one of the pre-defined occupancy classes. In the preferred embodiment, these classes include at least these classes: (i) empty, (ii) adult occupant, (iii) child occupant, (iv) rear-facing infant seat [RFIS], (v) front-facing infant seat [FFIS]. Within the adult occupant class, the seat occupancy is further classified into (i) in-position occupant, and (ii) out-of-position occupant, based on whether the occupant is determined to be within the “keep out zone” of the airbag. Additional occupancy classes may exist, such as differentiation between large adults and small adults, and recognition of small inanimate objects, such as books or boxes.

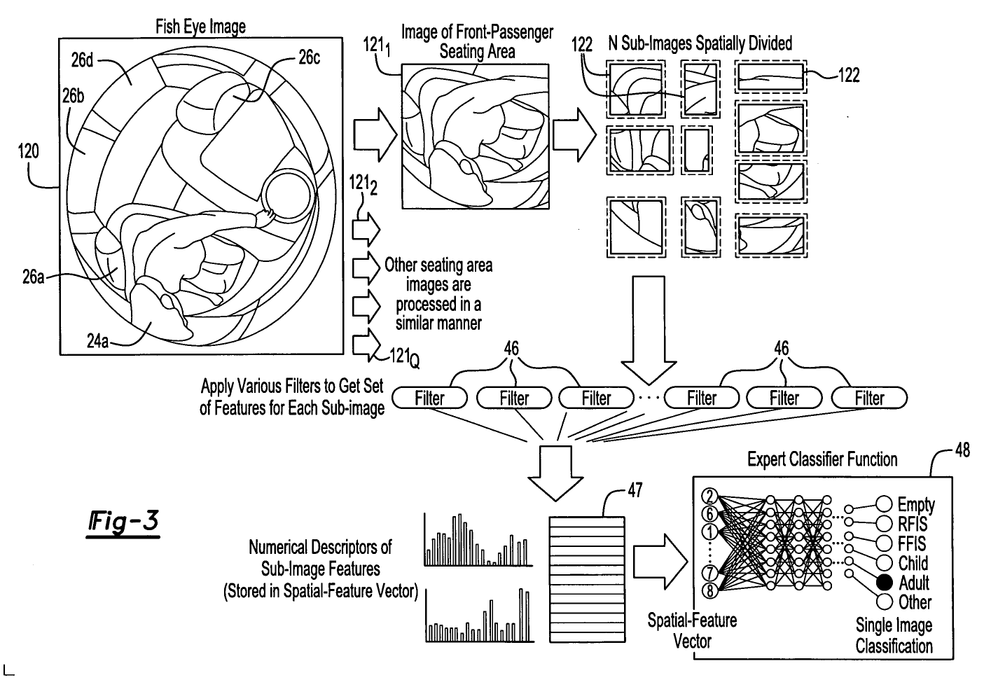

FIG. 3 conceptually shows the image classification method performed by the classifier 36. Referring to FIGS. 1-3, in step 89, the area image divider divides the image 120 into Q images, each associated with one of the plurality of seating areas 26 in the vehicle 22. In step 90 the image divider 42 divides each input image 120 into several sub-images 122 as defined by spatial window registers 44_{1-N}. The placement and dimensions of these spatial windows is a function of the geometry of the vehicle interior. Some of the spatial windows overlap with one another, but the spatial windows do not necessarily cover the entire image 120. Once the expert classifier function is trained (as described more below), the camera 28 may be moved, re-positioned, or placed in a different vehicle. The system 20 compensates for the change in vehicle geometry and perspective by altering the spatial windows as defined in spatial window registers 44.

In step 92, the digital filters 46 are then applied to each of these sub-images 122. These digital filters 46 generate numerical descriptors of various image features and attributes, such as edge and texture information. The response of these filters 46 may also be altered by the vehicle geometry parameters 51 in order to compensate for the spatial windows possibly being different in size than the spatial windows used during training. Grouped together, the output of the digital filters are stored in vector form and referred to as a spatial-feature matrix 47. This is due to the matrix's ability to describe both the spatial and image feature content of the image. This spatial-feature matrix 47 is used as the input to the expert classifier algorithm 48.

In step 94, the output of the expert classifier algorithm 48 is a single image occupancy classification (empty, adult, child, RFIS, FFIS, etc.). The expert classifier algorithm 48 may be any form of classifier function which exploits training data 50 and computational intelligence algorithms, such as an artificial neural network.

Single image classification is performed by a trainable expert classifier function. An expert classifier function is any special-purpose function which utilizes expert problem knowledge and training data in order to classify an input signal. This could take the form of any number of algorithmic functions, such as an artificial neural network (ANN), trained fuzzy-aggregate network, or Hausdorff template matching. In the preferred embodiment, an artificial neural network is used with a large sample set of training data which includes a wide range of seat occupancy scenarios. The process of training the classifier is done separately for each seating area. This is because the classifier can expect the same object (occupant, infant seat, etc.) to appear differently based on which seat it is in.

Each seat image is classified independently as the occupancy of each seat gives no information on the occupancy of the other seats in the vehicle. This process of image classification begins with the division of the seat image into several sub-images, defined by spatial windows in image-space. The placement and dimensions of these spatial windows is a function of the geometry of the vehicle interior. Once the expert classifier function is trained, the camera 28 may be moved, re-positioned, or placed in a different vehicle. The device 20 compensates for the change in vehicle geometry and perspective by altering the spatial windows. A set of digital filters are then applied to each of these sub-images. These digital filters generate numerical descriptors of various image features and attributes, such as edge and texture information. These filters may take any number of forms, such as a finite-impulse response (FIR) filter, an algorithmic filter, or a global band-pass filter. In general, these filters take an image as an input and output a stream of numerical descriptors which describe a specific image feature. The response of these filters may also be altered by the vehicle geometry parameters in order to compensate for the spatial windows possibly being different in size than the spatial windows used during training. For instance, the size and offset of a FIR filter may be affected by the measured vehicle geometry. Grouped together, the output of the digital filters are stored in vector form and is referred to as a spatial-feature vector 47. A separate spatial-feature vector 47 is generated for each seating area. This is due to the vector's ability to describe both the spatial and image feature content of the image. This spatial-feature vector 47 is used as the input to the expert classifier function 48. The output of the expert classifier function 48 is a single image occupancy classification (empty, in-position adult, out-of-position adult, child, RFIS, FFIS, etc.) for each seat 26. The expert classifier function 48 may be any form of classifier function which exploits training data and computational intelligence algorithms, such as an artificial neural network.

Training of the expert classifier function is done by supplying the function with a large set of training data 50 which represents a spectrum of seat scenarios. Preferably this will include several hundred images. With each image, a ground-truth is supplied to indicate to the function what occupancy classification this image should generate. While a large training set is required for good system performance, the use of spatially focused digital features to describe image content allows the classifier algorithm 48 to estimate which training sub-set the captured image is most similar to, even if it has not previously observed an image which is exactly the same.

To ensure that the knowledge learned by the expert classifier algorithm 48 in training is usable in any vehicle interior, the expert classifier algorithm 48 may be adjusted using system parameters 51 which represent the physical layout of the system. Once a mounting location for the camera 28 has been determined in a vehicle 22, physical measurements are taken which represent the perspective the camera 28 has of the occupant area 26, and the size of various objects in the vehicle interior. These physical measurements may be made manually, using CAD software, using algorithms which identify specific features in the image of the occupant area 26, or by any other means. These physical measurements are then converted into system parameters 51 which are an input to the expert classifier algorithm 48 and image divider 42. These parameters 51 are used to adjust for varying vehicle interiors and camera 28 placements by adjusting the size and placement of spatial windows as indicated in the spatial window registers 50, and through alteration of the digital filters 46. Altering the digital filters 46 is required to individually scale and transform the filter response of each sub-image. This allows the spatial-feature matrix 47 that is generated to be completely independent of camera 28 placement and angle. Consequently, the system 20 is able to calculate occupancy classifications from any camera 28 placement, in any vehicle 22.

In an alternative method, a known pattern may be placed on the occupant area 26. While in a calibration mode, the camera 28 then captures an image of the occupant area 26 with the known pattern. By analyzing the known pattern on the occupant area 26, the system 20 can deduce the system parameters 51 necessary to adapt to a new vehicle 22 and/or a new location/orientation within the vehicle 22.

The expert classifier algorithm 48 generates a single image classification based upon the analysis of a single image, the training data 50 and the system parameters 51. Transitions between occupancy classes will not be instantaneous, but rather they will be infrequent and gradual. To incorporate this knowledge, the single image classifications are temporally smoothed over the recent past by the temporal filter 52 in step 98 to produce a final seat occupancy classification.

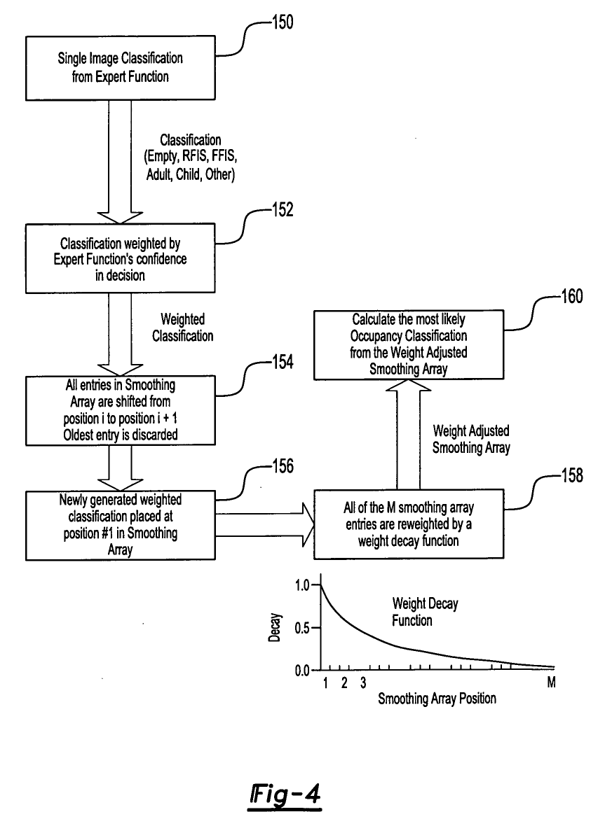

This temporal smoothing in step 98 of FIG. 2 occurs as shown in the flow chart of FIG. 4. The temporal smoothing is performed independently for each occupant area 26. The temporal filter 52 (FIG. 1) keeps a record of the past M single image classifications in a memory and receives the single image classification in step 150, which is weighted by the classifier algorithm's confidence level in that classification in step 152. Each classification record is weighted according to the classification confidence level calculated by the expert classifier algorithm 48. All the entries in the array are shifted one position, and the oldest entry is discarded in step 154. In step 156, the present weighted classification is placed at the first position in the array. All of the M image classifications are reweighted by a weight decay function, which weighs more recent classifications more heavily than older classifications in step 158. Older image classifications are made to influence the final outcome less than more recent image classifications. In step 160, the smoothed seat occupancy classification is then generated by summing the past M image classifications, with preferential weighting given to the most recently analyzed images. This temporal smoothing will produce a more robust final classification in comparison to the single image classification. As well, smoothing the classification output will avoid momentary spikes/changes in the image classification due to short-lived phenomena such as temporary lighting changes and shadows.

Referring to FIGS. 1 and 2, once the seat occupancy classification has been determined in step 98, the active restraint controller 38 determines the corresponding active restraint deployment settings. This algorithm associates the detected seat occupancy class with an air bag deployment setting, such as, but not limited to, “air bag enabled,” “air bag disabled,” or “air bag enabled at 50% strength.” Once the deployment settings are determined, these controller inputs are sent to the vehicle's air bag controller module which facilitates air bag deployment in the event of a crash, as determined by crash detector 32.

Although the main output requirement for the device is to interface to the airbag control system, visual display of detected occupancy state is also desirable. This may take them form of indicator lights or signals on the device (possibly for testing and debugging purposes), or alternatively, on the dashboard to allow the driver to see what the airbag deployment setting is. As well, for development and testing purposes, appropriate cabling and software should exist to allow the device to be hooked up to a personal computer which can visually illustrate the detected seat occupancy information.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for classifying an occupant including the steps of:
a. capturing an image of a plurality of occupant areas;
b. dividing the image into a plurality of subimages of predetermined spatial regions;
c. generating a spatial feature matrix of the image based upon the plurality of subimages;
d. analyzing the spatial feature matrix; and
e. classifying a plurality of occupants in the occupant areas based upon said step d).

2. The method of claim 1 further including the step of processing the image to account for lighting and motion before said step d).

3. The method of claim 1 further including the step of smoothing the classification of the occupant over time.

4. The method of claim 1 further including the step of determining whether to activate an active restraint based upon the classification of said step e).

5. The method of claim 1 wherein said step d) further includes the step of applying expert classifier algorithm to the spatial feature matrix.

6. The method of claim 5 wherein said step d) further includes the step of analyzing the spatial feature matrix based upon a set of training data.

7. The method of claim 6 further including the step of creating the set of training data by capturing a plurality of images of known occupant classifications of the occupant area.

8. The method of claim 5 wherein the expert classifier algorithm includes a neural network.

9. The method of claim 1 wherein the plurality of subimages overlap one another.

10. A vehicle occupant classification system comprising:
an image sensor for capturing an image of a plurality of occupant areas; and
a processor dividing the image into a plurality of subimages, the processor analyzing the subimages to determine a classification of the occupants in each of the plurality of occupant areas.

11. The vehicle occupant classification system of claim 10 wherein the processor determines the classification of the occupant from among the classifications including: adult, child and infant seat.

12. The vehicle occupant classification system of claim 11 wherein the processor determines the classification of the occupant from among the classifications including: adult, child, forward-facing infant seat and rearward-facing infant seat.

13. The vehicle occupant classification system of claim 10 wherein the processor generates a spatial feature matrix based upon the plurality of subimages.

14. The vehicle occupant classification system of claim 13 further including at least one filter generating the spatial feature matrix based upon the plurality of subimages.

15. The vehicle occupant classification system of claim 14 further including an image processor for altering the image based upon lighting conditions and based upon motion.

16. The vehicle occupant classification system of claim 15 wherein the processor analyzes the spatial feature matrix to determine the occupant classification using a neural network.

17. The vehicle occupant classification system of claim 10 further including a temporal smoothing filter applying a decaying weighting function to a plurality of previous occupant classifications to determine a present occupant classification.

18. The vehicle occupant classification system of claim 17 further including a confidence weighting function applied to the plurality of previous occupant classifications to determine the present occupant classification.

19. The vehicle occupant classification system of claim 10 further including a plurality of digital filters extracting low-level descriptors from each of the subimages, the processor analyzing the low-level descriptors to determine the classification of the occupant.

20. A method for classifying an occupant including the steps of:
a. capturing an image of a plurality of occupant areas;
b. dividing the image into a plurality of subimages of predetermined spatial regions;
c. generating a plurality of low-level descriptors from each of the plurality of subimages;
d. analyzing the low-level descriptors; and
e. classifying an occupant in each of the plurality of occupant areas based upon step d).

21. The method of claim 20 wherein said step d) further includes the step of analyzing the low-level descriptors based upon a set of training data.

22. The method of claim 21 further including the step of creating the set of training data by capturing a plurality of images of known occupant classifications of the occupant area.

23. The method of claim 20 wherein said steps d) and e) are performed using a neural network.

24. The method of claim 20 wherein said step d) is based upon system parameters including an orientation or a location from which the image is captured relative to the occupant area.
